(19) United States
(12) Patent Application Publication
(10) Pub. No.: US 2009/0194741 A1
(43) Pub. Date: Aug. 6, 2009

(54) Exhaust system having a carbon oxide catalyst

(75) Inventors: Herbert Florey Martins DaCosta, Peoria, IL (US); Thomas Edward Paulson, Groveland, IL (US); Svetlana Mikhailovna Zemskova, Edelstein, IL (US); James Joshua Driscoll, Dunlap, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc.

(21) Appl. No.: 12/010,968

(22) Filed: Jan. 31, 2008

(51) Int. Cl. C01B 13/00; B01J 15/00; C01B 31/00; F01N 3/10

(52) U.S. Cl. 252/372; 422/211; 60/299

(57) ABSTRACT

A catalytic filter system is disclosed. The catalytic filter system contains a catalyst including a ternary nitride and at least one of gold, osmium, iridium, palladium, rhodium, rhenium, ruthenium, or cesium. The catalytic filter system may further include an energy source situated to impart energy to the catalyst.

### TECHNICAL FIELD

The present disclosure relates generally to an exhaust system and, more particularly, to an exhaust system having a carbon oxide catalyst.

### BACKGROUND

Internal combustion engines, including diesel engines, gasoline engines, natural gas engines, and other engines known in the art exhaust a complex mixture of chemical pollutants. The chemical pollutants may include solid particulate matter, including soot, and gaseous compounds, which may include nitrogen oxides (NOx) and carbon dioxide (CO₂). Due to increased attention on the environment, exhaust emission standards have become more stringent, and the amount of pollutants emitted to the atmosphere from an engine may be regulated depending on the type of engine, size of engine, and/or class of engine.

One method that has been implemented by engine manufacturers to comply with the regulation of particulate matter exhausted to the environment has been to remove the matter from the exhaust flow of an engine with particulate filters. To comply with the regulation of gaseous compounds, manufacturers have included various catalysts within the filters to purify the exhaust gas from the engine before emitting the gas to the atmosphere. These catalysts convert harmful gaseous compounds such as NOx, into innocuous constituents such as elemental nitrogen (N₂) and oxygen (O₂). The catalysts include base metal oxides, molten salts, and/or precious metals. However, these materials are costly, unsuited to the high temperature environment that can be present inside a particulate filter, and incapable of decomposing CO₂.

A method of converting carbon is disclosed in U.S. Pat. No. 5,068,057 (the '057 application), issued to Gustafson et al. on Aug. 31, 2007. The '057 application discloses a method of contacting carbon dioxide with at least one hydrocarbon in the presence of a catalyst consisting essentially of a metal selected from platinum or palladium supported on an alumina or silica-alumina support. The reaction is carried out at a temperature of about 650° C.-1000° C.

Although the particulate filter of the '077 patent may provide an catalytically active structure capable of withstanding high temperatures and decomposing CO₂ gases into CO, the catalyst may still be expensive and unsuited to use in a particulate filter.

The disclosed exhaust system is directed to overcoming one or more of the problems set forth above.

### SUMMARY

In one aspect, the present disclosure is directed to a catalytic filter system containing a catalyst. The catalyst may include a ternary nitride and at least one of gold, osmium, iridium, palladium, rhodium, rhenium, ruthenium, or cesium. The catalytic filter system may further include an energy source situated to impart energy to the catalyst.

In another aspect, the present disclosure is directed to a method of decomposing a carbon oxide. The method may include adsorbing the carbon oxide and a separate reactant onto the surface of a catalyst containing a ternary nitride. The method may further include providing energy to react the adsorbed carbon oxide with the separate reactant.

### BRIEF DESCRIPTION OF THE DRAWINGS

FIG. 1 is a diagrammatic illustration of an engine having a catalyst system according to an exemplary disclosed embodiment.

### DETAILED DESCRIPTION

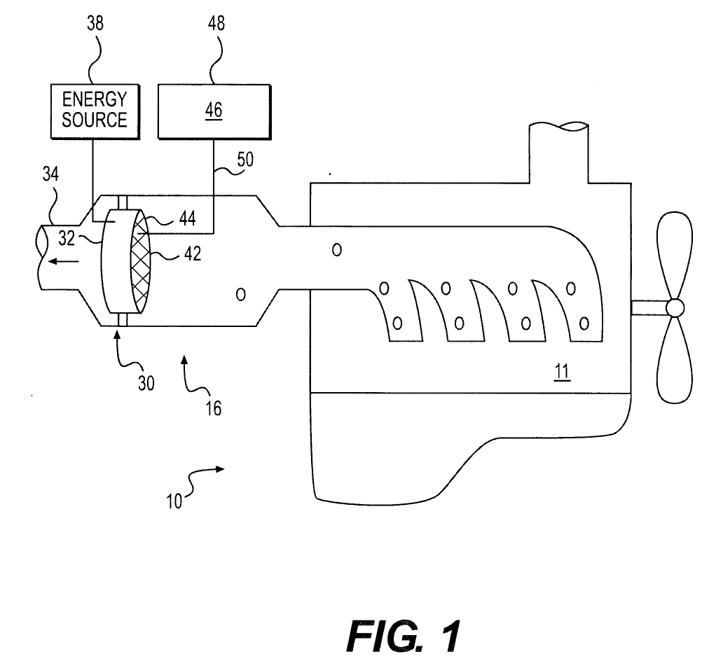

FIG. 1 illustrates an exemplary power source 10. The power source 10 may include an engine 11 such as, for example, a diesel engine, a gasoline engine, a gaseous fuel-powered engine, or any other engine apparent to one skilled in the art. The power source 10 may, alternatively, include a non-engine source of power such as a furnace. The power source 10 may include an exhaust system 16 that directs exhaust away from the engine 11.

The exhaust system 16 may include components that direct and/or treat exhaust from the engine 11. In particular, the exhaust system 16 may include a filter system 30 and an exhaust outlet 34. The exhaust from the engine 11 may pass through the filter system 30 to the exhaust outlet 34 before discharge to the atmosphere. It is contemplated that additional emission-controlling devices may be included within the exhaust system 16, if desired.

The filter system 30 may be placed downstream of the engine 11 to remove particulates from the exhaust and catalyze gaseous compounds. The filter system may include a particulate filter 36, an energy source 38, and a catalyst 42.

The particulate filter 36 may remove particulate matter from the exhaust. The particulate filter 36 may contain a filter material 44 that may include electrically conductive coarse mesh elements that have been compressed and/or sintered together under pressure. It is further contemplated that the filter material 44 may, alternatively, include electrically non-conductive coarse mesh elements such as, for example, porous elements formed from a ceramic material or a high-temperature polymer. It is also contemplated that more than one particulate filter 36 may be included within the exhaust system 16 and disposed in series or parallel relation.

The catalyst 42 may be applied as a wash coating to the filter material 44 in a conventional manner. In another embodiment, the catalyst 42 may be combined with the filter material 44 to form an alloy fiber. For example, the catalyst 42 may be added to an alloy such as FeCrAlY to form a metallic fiber alloy. The catalytically active alloy fiber may then be used to form a coarse mesh web element with a thickness of about 0.3-3 mm thick. Multiple layers of web elements may be combined to form the filter material 44 with a porosity of about 70-99%. The high porosity achieved by using web elements results in a low pressure drop across the particulate filter 36 and minimal impact on engine performance. The web elements may be sintered together under pressure, or in an alternate embodiment, may be used as a non-sintered metal fiber web filter. It is further considered that the mesh layers may vary in their material composition. Furthermore, it is considered that the catalyst may be used independent of a particulate filter, for example, the catalyst may be used in a flow-through or wall-flow filter application.

The catalyst 42 may be an multi-metallic nitride material, that is, a nitride combined with one ore more metallic elements. The catalyst 42 may be configured to decompose CO₂ and may be formed by modifying a ternary nitride such as tantalum oxynitride (TaON), magnesium boron nitride (MgB₉N), samarium sulfur nitride (Sm₃S₃N), or magnesium silicon nitride (MgSiN₂) to include one or more of the following elements: gold (Au), osmium (Os), iridium (Ir), palladium (Pd), rhodium (Rh), rhenium (Re), ruthenium (Ru), and/or cesium (Cs). For example, the catalyst 42 may be represented as TaXON, where X represents one or more of the elements listed above. The multi-metallic nitride catalyst 42 may be synthesized from the ternary nitride and elements listed above using, for example, low-temperature liquid synthesis such as described by Schaak et al., in the Journal of American Chemical Society 127, 3506-3515 (2005), low temperature solid synthesis such as described by Henkes et al., in Chem. Mater. 567-571 (2006), or any other method known in the art for synthesizing intermetallic nanoparticles. It is further considered that a ternary nitride alone (i.e. without the addition of the above-mentioned elements, or other compounds) may function as the catalyst 42. Although several possible catalysts are listed in Table 1 below as examples, other combinations may be possible.

TABLE 1

| | | Ternary Nitride | | | |
|---|---|---|---|---|---|
| | | TaON | MgB₉N | Sm₃S₃N | MgSiN₂ |
| Element | Au | TaAuON | MgAuB₉N | Sm₃AuS₃N | MgAuSiN₂ |
| | Os | TaOsON | MgOsB₉N | Sm₃OsS₃N | MgOsSiN₂ |
| | Ir | TaIrON | MgIrB₉N | Sm₃IrS₃N | MgIrSiN₂ |
| | Pd | TaPdON | MgPdB₉N | Sm₃PdS₃N | MgPdSiN₂ |
| | Rh | TaRhON | MgRhB₉N | Sm₃RhS₃N | MgRhSiN₂ |
| | Re | TaReON | MgReB₉N | Sm₃ReS₃N | MgReSiN₂ |
| | Ru | TaRuON | MgRuB₉N | Sm₃RuS₃N | MgRuSiN₂ |
| | Cs | TaCsON | MgCsB₉N | Sm₃CsS₃N | MgCsSiN₂ |

The catalyst 42 may enable CO₂ conversion by first adsorbing CO₂ gas and an additional gaseous reactant 46 onto the surface of the catalyst 42. The CO₂ and additional reactant 46 may react in the presence of external energy, for example heat provided by the energy source 38, to form a product. Finally, the product may desorb from the surface of the catalyst 42.

The external energy required for the reaction of CO₂ and the additional reactant 46 may be dependant on the composition of the reactant 46. For example, the reactant 46 may be hydrogen (H₂), water (H₂O), methane (CH₄), ethylene (C₂H₄), acetylene (C₂H₂), benzene (C₆H₆), or phenol (C₆H₅OH). The reactions of these compounds with CO₂, including a reaction free energy (ΔG) for each reaction, are described by Xiaoding et al, in Energy & Fuels 10, 305-325 (1996) and shown in Table 2 below. As shown in Table 2, the reactions may have positive reaction free energies and, thus, energy source 38 may provide the external energy required for the reaction to occur.

TABLE 2

| Reactions | ΔG | Equation |
|---|---|---|
| CO₂(ads) + H₂(ads) → HCCOH(l) | +34.3 | (1) |
| CO₂(ads) + 2H₂(ads) → HCHO(g) + 2H₂O | +46.6 | (2) |
| CO₂(ads) + 3H₂(ads) → CH₃OH(l) + H₂O(l) | −10.7 | (3) |
| CO₂(ads) + 4H₂(ads) → CH₄(g) + ₂H₂O(l) | −132.4 | (4) |
| 2CO₂(ads) + H₂(ads) → (COOH)₂(l) | +85.3 | (5) |
| 2CO₂(ads) + 6H₂(ads) → CH₃OCH₃(g) + 3H₂O(l) | −38.0 | (6) |
| CO₂(ads) + H₂(ads) + CH₃OH(l) → HCOOH₃(l) + H₂O(l) | +25.8 | (7) |
| CO₂(ads) + H₂(ads) + CH₃OH(l) → CH₃COOH (l) + H₂O(l) | −63.6 | (8) |
| CO₂(ads) + 3H₂(ads) → CH₃OH(l) → C₂H₅(l) + 2H₂O(l) | −88.9 | (9) |
| CO₂(ads) + H₂(ads) + NH₃(ads) → HCONH₂(l) + H₂O(l) | +7.2 | (10) |
| CO₂(ads) + CH₄(ads) → CH₃COOH(l) | +58.1 | (11) |
| CO₂(ads) + CH₄(ads) + H₂(ads) → CH₃CHO(l) + H₂O(l) | +74.4 | (12) |
| CO₂(ads) + CH₄(ads) + 2H₂(ads) → (CH₃)₂CO(l) + H₂O(l) | +51.2 | (13) |
| CO₂(ads) + C₂H₂(ads) + H₂(ads) → CH₂ + CHCOOH(l) | −115.0 | (14) |
| CO₂(ads) + C₂H₄(ads) → CH₂ + CHCOOH(l) | +26.2 | (15) |
| CO₂(ads) + C₂H₄(ads) + H₂(ads) → C₂H₅COOH(l) | −56.6 | (16) |
| CO₂(ads) + C₂H₄(ads) + 2H₂(ads) → C₂H₅CHO(l) + H₂O(l) | −44.4 | (17) |
| CO₂(ads) + C₅H₆(l) → C₅H₅COOH(l) | +30.5 | (18) |
| CO₂(ads) + C₅H₅OH(l) → C₆H₄(OH)COOH(l) | +46.9 | (19) |
| CO₂(ads) + CH₂(ads) → CH₂CH₂O(l) + CO(g) | +177.3 | (20) |
| CO₂(ads) + C(s) → 2CO(g) | +119.9 | (21) |
| 3CO₂(ads) + CH₄(ads) → 4CO(g) + 2H₂O(I) | +209.2 | (22) |
| CO₂(ads) + CH₄(ads) → 2CO(g) + 2H₂(g) | +170.8 | (23) |
| CO₂(ads) + 2CH₄(ads) → C₂H₆(g) + CO(g) + H₂O(I) | +88.0 | (24) |
| 2CO₂(ads) + 2CH₄(ads) → C₂H₄(g) + ZCO(g) + 2H₂O(I) | +208.3 | (25) |
| CO₂(ads) + C₂H₄(ads) → C₂H₄O(g) + CO(g) | +176.0 | (26) |

The energy source 38 may be an inexpensive energy supply, capable of providing to the catalyst 42 the energy required to overcome the positive free energy of reaction of CO₂ with the reactant 46. For example, the energy source may be a photovoltaic cell (not shown). The energy source 38 may provide energy to the catalyst 42 in the form of heat, light, or electrical charge.

The additional reactant 46 may, for example, be stored in a tank 48 and provided to catalyst 42 via a fluid passageway 50. The tank 48 may be any storage receptacle appropriate for storing a pressurized gas. It is further considered that the reactant 46 may have been previously adsorbed onto the surface of the catalyst 42, for example during the synthesis of the catalyst material, so that the tank 48 and fluid passageway may be omitted.

It is further considered that the catalyst 42 and the energy source 38 may enable CO conversion in a manner similar to that discussed above. The reactant 46 required for CO conversion may include hydrogen, water, methanol (CH₃OH), ammonia (NH₃), acetylene, or ethylene. The reactions of these species with CO, including a reaction free energy for each reaction, are also described by Xiaoding et al and shown in Table 3 below.

TABLE 3

| Reactions | ΔG | Equation |
|---|---|---|
| CO(ads) + 2H₂(ads) → CH₃OH(l) | −29.9 | (27) |
| CO(ads) + H₂O(ads) → HCOOH(l) | +15.1 | (28) |
| 2CO(ads) + 2H₂C(l) → (COOH)₂(l) | +46.9 | (29) |
| CO(ads) + CH₃OH(l) → HCOOCH₃(l) | −6.6 | (30) |
| CO(ads) + CH₃OH(l) → CH₃COOH(l) | −82.8 | (31) |
| CO(ads) + NH3(ads) → HCONH₂(l) | 12.0 | (32) |
| CO(ads) + C₂H₂(ads) + H₂O(I) → CH₂ + | −134.2 | (33) |
| CHCOOH(l) | | |
| CO(ads) + C₂H₄(ads) + H₂(ads) → C₂H₃CHO(l) | −63.6 | (34) |

### INDUSTRIAL APPLICABILITY

The disclosed carbon oxide catalyst may be applicable to any combustion-type device, such as an engine or a furnace, where the reduction of CO and/or CO₂ emissions is desired. The disclosed carbon oxide catalyst may facilitate the conversion of harmful CO and/or CO₂. In addition, the carbon oxide catalyst may function without substantially impacting flow of exhaust through the DPF. Operation of the carbon oxide catalyst will now be explained.

Atmospheric air may be drawn into a combustion chamber of the engine 11. Fuel may be mixed with the air before or after entering the combustion chamber. This fuel-air mixture may be combusted by the engine 11 to produce mechanical work and an exhaust flow containing solid particulate matter and gaseous compounds, including CO₂.

The exhaust gas flow may be directed to the filter system 30 where particulate matter entrained with the exhaust flow may be filtered by the particulate filter 36. As the exhaust gas passes through the particulate filter 36, CO₂ gases may be exposed to the catalyst 42. The catalyst 42 may be of the form TaON, MgB₉N, Sm₃S₃N, MgXSiN₂, TaXON, MgXB₉N, Sm₃XS₃N, or MgXSiN₂, where X represents one or more of the elements Au, Os, Ir, Pd, Rh, Re, Ru, and Cs. The additional reactant 46 may be supplied by the tank 48 via the fluid passageway 50 and adsorb onto the surface of the catalyst 42. Energy from the energy source 38 may facilitate the reaction of CO₂ and the reactant 46. The product formed by the reaction may then desorb from the surface of the catalytic material.

It is further considered that the catalyst 42 and the energy source 38 may enable CO conversion in a manner similar to that discussed above. Furthermore, it is considered that the product created by the reaction of CO₂ and/or CO may function as a syngas used to produce a fuel via a Fischer-Tropsch synthesis, in a manner known in the art. For example, the product may be heated to 220-270° C. at 10-50 atmospheres of pressure to produce a synthetic fuel. The synthetic fuel may be used, for example, for combustion in the engine 10.

Several advantages may be associated with the carbon oxide catalyst of the present disclosure. Specifically, the disclosed system may be an inexpensive, effective solution for purifying CO₂ and/or CO gases. The disclosed catalyst may provide a catalyst capable of withstanding the high temperatures of a DPF environment without requiring excessive temperatures in order to maintain its effectiveness. Furthermore, the disclosed carbon oxide catalyst may provide these benefits without significantly impacting flow through the DPF.

It will be apparent to those skilled in the art that various modifications and variations can be made to the disclosed carbon oxide catalyst. Other embodiments will be apparent to those skilled in the art from consideration of the specification and practice of the disclosed carbon oxide catalyst. It is intended that the specification and examples be considered as exemplary only, with a true scope being indicated by the following claims and their equivalents.

What is claimed is:

1. A catalytic filter system, comprising:
a catalyst including:
a ternary nitride; and
at least one of gold, osmium, iridium, palladium, rhodium, rhenium, ruthenium, or cesium; and
an energy source situated to impart energy to the catalyst.

2. The catalytic filter system of claim 1, wherein the ternary nitride is at least one of tantalum oxynitride, magnesium boron nitride, samarium sulfur nitride, or magnesium silicon nitride.

3. The catalytic filter system of claim 1, wherein the energy source is a photovoltaic cell.

4. The catalytic filter system of claim 1, further including at least one of hydrogen, water, methane, ethylene, acetylene, benzene, or phenol.

5. The catalytic filter system of claim 1, wherein the energy source provides a reaction energy required for the reaction of carbon dioxide with at least one of hydrogen, water, methane, ethylene, acetylene, benzene, phenol, or ammonia.

6. The catalytic filter system of claim 1, wherein the energy source provides a reaction energy required for the reaction of carbon monoxide with at least one of hydrogen, water, methanol, ammonia, acetylene, or ethylene.

7. The catalytic filter system of claim 1, wherein the catalyst is combined with a filter material to form an alloy fiber and the alloy fiber forms a web.

8. The catalytic filter system of claim 7, wherein the filter material is FeCrAlY.

9. The catalytic filter system of claim 7, wherein the web has a porosity of about 70-99%.

10. The catalytic filter system of claim 1, wherein the catalyst is applied as a coating to a filter material.

11. An exhaust treatment system comprising:
an engine configured to produce power and a flow of exhaust; and
a filter system situated to receive the flow of exhaust from the engine, wherein the filter system includes:
a base material;
a catalyst integrated with the base material, wherein the catalyst includes:
a ternary nitride; and
at least one of gold, osmium, iridium, palladium, rhodium, rhenium, ruthenium, or cesium; and
an energy source configured to direct energy to the catalyst.

12. The exhaust treatment system of claim 11, wherein the ternary nitride contains at least one of tantalum oxynitride, magnesium boron nitride, samarium sulfur nitride, or magnesium silicon nitride.

13. The exhaust treatment system of claim 11, further including at least one of hydrogen, methane, ethylene, acetylene, benzene, or phenol.

14. The exhaust treatment system of claim 11, wherein the energy source provides a reaction energy required for the reaction of carbon dioxide and at least one of hydrogen, water, methane, ethylene, acetylene, benzene, or phenol.

15. The exhaust treatment system of claim 11, wherein the energy source provides a reaction energy required for the reaction of carbon monoxide and at least one of hydrogen, water, methanol, ammonia, acetylene, or ethylene.

16. The exhaust treatment system of claim 11, wherein the energy source is a photovoltaic cell.

17. A method of decomposing a carbon oxide comprising:
adsorbing the carbon oxide and a separate reactant onto the surface of a catalyst containing a ternary nitride;
providing energy to react the adsorbed carbon oxide with the separate reactant.

18. The method of claim 17, wherein providing energy includes providing energy in the form of at least one of light, heat, or electrical charge.

19. The method of claim 17, wherein adsorbing the carbon oxide includes adsorbing carbon dioxide, and adsorbing the separate reactant includes adsorbing at least one of hydrogen, water, methane, ethylene, acetylene, benzene, or phenol.

20. The method of claim 17, wherein adsorbing the carbon oxide includes adsorbing carbon monoxide, and adsorbing the separate reactant includes adsorbing at least one of hydrogen, water, methanol, ammonia, acetylene, or ethylene.
